(19) United States
(12) Patent Application Publication
(10) Pub. No.: US 2006/0214576 A1
(43) Pub. Date: Sep. 28, 2006

(54) Electroluminescent display device

(75) Inventors: Kenji Takahashi, Kanagawa-ken (JP); Tomotake Ikada, Kanagawa-ken (JP); Hiroshi Fujimoto, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/387,735

(22) Filed: Mar. 24, 2006

(30) Foreign Application Priority Data
Mar. 25, 2005 (JP) 089698/2005

(51) Int. Cl. H01J 1/62; H01J 63/04

(52) U.S. Cl. 313/506

(57) ABSTRACT

An electroluminescent display device is formed by superposing a support member, a first electrode layer, a light-emitting layer, a second electrode layer which transmits light and a color conversion filter layer in this order. The light-emitting layer is formed by dispersing electroluminescent light-emitting particles which emit a predetermined color of light in a dielectric binder. The color conversion filter layer includes color conversion portions and/or transparent portions which transmit light. The first electrode layer and the second electrode layer form an X-Y matrix electrode. Further, the EL light-emitting layer is uniformly formed over the entire area of the electroluminescent display device.

### BACKGROUND OF THE INVENTION

1. Field of the Invention

The present invention relates to an electroluminescent display device including an electroluminescent light-emitting layer.

2. Description of the Related Art

An electroluminescent element is expected to be utilized as a self-luminous area light source or as a new display device which does not require a separate light source. Conventionally, there are two kinds of electroluminescent elements, namely a “dispersion-type” element and a “thin-film-type” element (please refer to “Electroluminescent Display”, Toshio Inoguchi, first edition, Sangyo Tosho Co., Ltd., Jul. 25, 1991, pp. 9-20).

Further, application of the electroluminescent display to a color display is currently in progress. An electroluminescent element which emits sufficiently high brightness light for use as a display has been proposed in the U.S. Patent Application Publication No. 20040119400. The electroluminescent element disclosed in the U.S. Patent Application Publication No. 20040119400 is a dispersion-type electroluminescent element. In the dispersion-type electroluminescent element, particles made of a phosphor, which was conventionally used to form a light-emitting layer of a thin-film-type electroluminescent element, are freely dispersed in a light-emitting layer of the electroluminescent element. Further, another kind of dispersion-type electroluminescent element has been proposed. In the other kind of dispersion-type electroluminescent element, a particle, in which a dielectric core is directly coated with a phosphor coating layer, or a particle, in which the phosphor coating layer is further directly coated with a dielectric coating layer, is used instead of a particle which is only made of a phosphor. Further, in the dispersion-type electroluminescent element, a phosphor, which has been used to form a light-emitting layer of a conventional thin-film-type element, is used as a material for the phosphor coating layer.

Meanwhile, an inorganic EL (electroluminescent) display has been proposed by iFire Technology Corp. (iFire Technology Corp., [on-line], [searched on Mar. 15, 2005], Internet <URL:http://www.ifire.com/Technology/Demo.aspx>.

A light-emitting layer used in the display disclosed in the homepage of iFire Technology Corp is a thin-film-type EL layer. Generally, the brightness of light emitted from a thin-film-type EL layer is higher than that of light emitted from a dispersion-type EL layer. However, a process of producing the thin-film-type EL layer is more complex than a process of producing the dispersion-type EL layer, and a production cost of the thin-film-type EL layer tends to become high. Further, there is a problem that light extraction efficiency of the thin-film-type EL layer is extremely low.

As a display (electroluminescent display device) in which an electroluminescent element is used, there is a need for a display which can stably display high brightness images, and which can be produced at low cost.

### SUMMARY OF THE INVENTION

In view of the foregoing circumstances, it is an object of the present invention to provide an electroluminescent display device which displays high brightness images, and which is produced at low cost.

An electroluminescent display device according to the present invention is an electroluminescent display device comprising:

a support member;

a first electrode layer;

a plane-shaped light-emitting layer;

a second electrode layer which transmits light; and

a color conversion filter layer, wherein the plane-shaped light-emitting layer is formed by dispersing electroluminescent light-emitting particles which emit a predetermined color of light in a dielectric binder, and wherein the color conversion filter layer includes a multiplicity of color conversion portions which convert the color of the light and/or a multiplicity of transparent portions which transmit the light, and wherein the support member, first electrode layer, plane-shaped light-emitting layer, second electrode layer and color conversion filter layer are superposed in this order, and wherein each of the first electrode layer and the second electrode layer includes a plurality of line-shaped electrodes, and wherein the plurality of line-shaped electrodes of the first electrode layer and that of the second electrode layer cross each other, and wherein the plane-shaped light emission layer is uniformly formed over the entire area of the electroluminescent display device.

The plurality of line-shaped electrodes of the first electrode layer and that of the second electrode layer should cross each other. Particularly, it is preferable that the plurality of line-shaped electrodes of the first electrode layer and that of the second electrode layer are orthogonal to each other. Here, portions (intersections) of the line-shaped electrodes, at which the line-shaped electrodes of the first electrode layer and those of the second electrode layer cross each other, form pixels. Further, the term “cross” refers to a state in which the line-shaped electrodes of the first electrode layer and those of the second electrode layer cross each other in a plan view in which both of the line-shaped electrodes are illustrated. The term “orthogonal” refers to a state in which the line-shaped electrodes of the first electrode layer and those of the second electrode layer are orthogonal to each other in a plan view in which both of the line-shaped electrodes are illustrated. In other words, the line-shaped electrodes of the first electrode layer and those of the second electrode layer cross each other or are orthogonal to each other, but they are not in direct contact with each other.

The electroluminescent display device of the present invention includes the aforementioned layers. However, those layers are described as minimum necessary elements for forming the electroluminescent display device. Therefore, in addition to the aforementioned layers, another layer or layers, such as an insulating layer, buffer layer or surface protective layer, may be formed on one side or either side of the light-emitting layer.

Particularly, it is preferable that at least a single insulating layer is provided between the first electrode layer and the second electrode layer. In other words, it is preferable that an insulating layer is formed on one side or either side of the light-emitting layer.

Further, it is preferable that the color conversion filter layer is arranged so that each of display pixels formed by intersections of the plurality of line-shaped electrodes of the first electrode layer and that of the second electrode layer, which cross each other, corresponds to one of the color conversion portions or one of the transparent portions.

Further, it is preferable that the color conversion filter layer includes an absorption portion which is formed between adjacent color conversion portions, between adjacent transparent portions or between a color conversion portion and a transparent portion which are adjacent to each other, wherein the absorption portion absorbs at least a part of light emitted from the light-emitting layer. Further, it is preferable that the color of the absorption portion is black.

The term “electroluminescent light-emitting particle” refers to the whole particle. When the electroluminescent light-emitting particle is used in an electroluminescent element, the term “electroluminescent light-emitting particle” refers to the whole portion of each of particles which are dispersed in a light-emitting layer. Specifically, in electroluminescence, light is actually emitted from the phosphor portion of the particle. However, in the present invention, the whole particle which includes the dielectric core or, if any, a dielectric coating layer, buffer layer or the like is referred to as “electroluminescent light-emitting particle.”

Further, the “electroluminescent light-emitting particle” is a phosphor particle, a particle, in which a phosphor layer is formed on the surface of a dielectric particle, a particle, in which a dielectric surface coating layer is formed on the surface of a phosphor particle, a particle, in which a phosphor layer and a dielectric surface coating layer are formed on the surface of a dielectric particle, or the like, for example.

Further, in the present invention, a multiplicity of electroluminescent light-emitting particles is “dispersed” in the dielectric binder. The term “dispersed” refers not only to a state in which each of the electroluminescent light-emitting particles is freely dispersed so as to be completely apart from each other but also to a state in which a part of the electroluminescent light-emitting particles are in contact with each other.

In the electroluminescent light-emitting element of the present invention, it is preferable that each of the electroluminescent light-emitting particles includes a dielectric core and a phosphor coating layer which is formed on the outside of the dielectric core. Further, it is preferable that when a voltage is applied between the first electrode layer and the second electrode layer, the strength of an average voltage applied to the phosphor coating layer is more than or equal to 1.5 times that of an average electric field applied to the entire light-emitting layer.

Alternatively, in the electroluminescent light-emitting element of the present invention, it is preferable that each of the electroluminescent light-emitting particles includes a dielectric core, a phosphor coating layer which is formed on the outside of the dielectric core and a dielectric coating layer which is formed on the outside of the phosphor coating layer. Further, it is preferable that when a voltage is applied between the first electrode layer and the second electrode layer, the strength of an average voltage applied to the phosphor coating layer is more than or equal to 1.5 times that of an average electric field applied to the entire light-emitting layer.

When each of the electroluminescent light-emitting particles includes the dielectric core and the phosphor coating layer formed on the outside of the dielectric core,

1) an additional layer such as a buffer layer may be formed between the dielectric core and the phosphor coating layer.

Alternatively, an additional pair of a dielectric coating layer and a phosphor coating layer, a surface protective layer or the like may be formed on the outside of the phosphor coating layer.

2) It is preferable that the average core diameter of the dielectric core of each of the electroluminescent particles dispersed in the binder is greater than or equal to 1.2μm and that the thickness of the light-emitting layer is less than or equal to 100 μm.

3) It is preferable that the average thickness r₁ of the phosphor coating layer and the average radius r₂ of the dielectric core in each of the electroluminescent light-emitting particles dispersed in the binder satisfy r₂/r₁≧1.0.

4) It is preferable that the relative dielectric constant ε₁ of the phosphor coating layer and the relative dielectric constant ε₂ of the dielectric core in each of the electroluminescent light-emitting particles dispersed in the binder satisfy ε₂/ε₁>2.0.

Meanwhile, when each of the electroluminescent light-emitting particles includes the dielectric core, the phosphor coating layer formed on the outside of the dielectric core and the dielectric coating layer formed on the outside of the phosphor coating layer,

1) an additional layer such as a buffer layer may be formed between the dielectric core and the phosphor coating layer and/or between the phosphor coating layer and the dielectric coating layer. Alternatively, an additional pair of a phosphor coating layer and a dielectric coating layer, a surface protective layer or the like may be formed on the outside of the dielectric coating layer.

2) It is preferable that the average core diameter of the dielectric core of each of the electroluminescent particles dispersed in the binder is greater than or equal to 1.2 μm and that the thickness of the light-emitting layer is less than or equal to 100 μm.

3) It is preferable that the average thickness r₁ of the phosphor coating layer, the average radius r₂ of the dielectric core and the average thickness r₃ of the dielectric coating layer in each of the electroluminescent light-emitting particles dispersed in the binder satisfy r₂/r₁≧1.0 and r₃/(r₁+r₂)<0.50.

4) It is preferable that the relative dielectric constantε₁ of the phosphor coating layer, the relative dielectric constant ε₂ of the dielectric core, and the relative dielectric constantε₃ of the dielectric coating layer in each of the electroluminescent light-emitting particles dispersed in the binder satisfy ε₂/ε₁>2.0 and ε₃/ε₁<20.

When the electroluminescent light-emitting particle includes a phosphor coating layer, it is preferable that the phosphor coating layer is made of a phosphor including a luminescent center which is excited by collision of a hot electron.

Further, it is preferable that the volume filling ratio of the electroluminescent light-emitting particles in the light light-emitting layer is greater than or equal to 40%.

In the electroluminescent display device of the present invention, the first electrode layer includes a plurality of line-shaped electrodes and the second electrode layer includes a plurality of line-shaped electrodes, and the line-shaped electrodes of the first electrode layer and those of the second electrode layer cross each other. Further, the light-emitting layer is uniformly formed through the entire area of the electroluminescent display device. Since the structure of the electroluminescent display device of the present invention is simple, the electroluminescent display device can be easily produced, and a production cost of the electroluminescent display device is low.

Further, electroluminescent light-emitting particles which emit a predetermined color of light are dispersed in the dielectric binder in the light-emitting layer. Therefore, it is possible to display high brightness images.

Particularly, if each of the electroluminescent light-emitting particles includes the dielectric core and the phosphor coating layer formed on the outside of the dielectric core and if when an voltage is applied between the first electrode layer and the second electrode layer, the strength of an average voltage applied to the phosphor coating layer is greater than or equal to 1.5 times that of an average electric field applied to the entire light-emitting layer, it is possible to display images at an even higher brightness level. Alternatively, if each of the electroluminescent light-emitting particles includes the dielectric core, the phosphor coating layer formed on the outside of the dielectric core and the dielectric coating layer formed on the outside of the phosphor coating layer, and if when an voltage is applied between the first electrode layer and the second electrode layer, the strength of an average voltage applied to the phosphor coating layer is greater than or equal to 1.5 times that of an average electric field applied to the entire light-emitting layer, it is possible to display images at an even higher brightness level.

### BRIEF DESCRIPTION OF THE DRAWINGS

FIG. 1 is a perspective view illustrating the layer structure of a display in an embodiment of an electroluminescent display device according to the present invention;

FIG. 2A is a plan view illustrating an X-Y matrix electrode;

FIG. 2B is a plan view illustrating a color conversion filter layer;

FIG. 3A is a sectional view of an electroluminescent light-emitting particle dispersed in a light-emitting layer;

FIG. 3B is a sectional view of an electroluminescent light-emitting particle dispersed in a light-emitting layer;

FIG. 4A is a partial sectional view of the light-emitting layer; and

FIG. 4B is a partial sectional view of the light-emitting layer.

### DESCRIPTION OF THE PREFERRED EMBODIMENTS

Hereinafter, embodiments of the present invention will be described in detail with reference to the attached drawings.

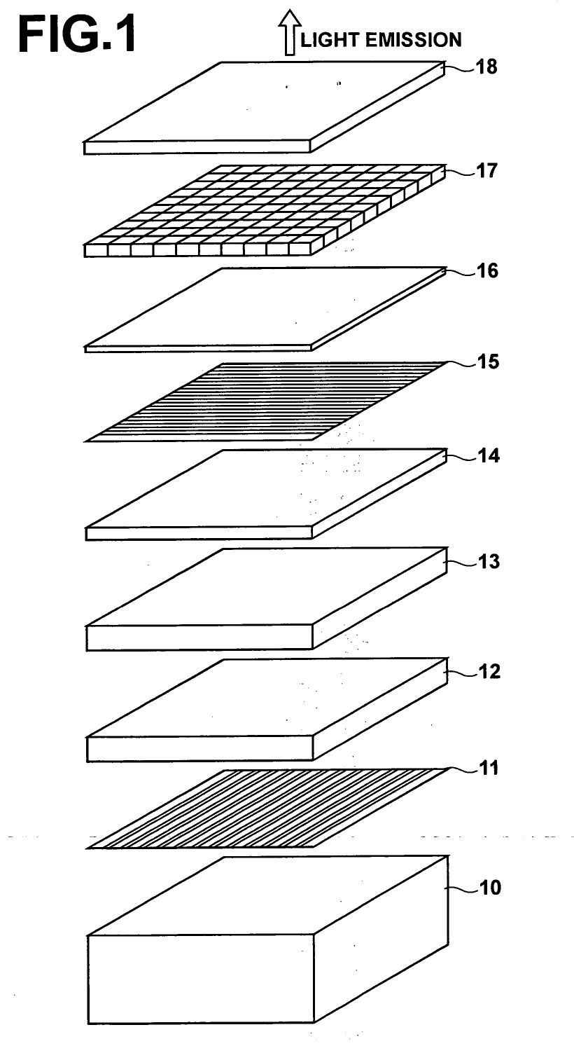

FIG. 1 is an exploded perspective view illustrating the layer structure of a color display which is an embodiment of an electroluminescent display device according to the present invention. FIG. 1 is a schematic view for explaining the structure of the color display. Therefore, in FIG. 1, the thickness or size of each layer is not an actual thickness or size.

The color display according to the present embodiment includes a white support member 10 and an optically transparent first electrode layer 11, which transmits light. The color display also includes a first insulating layer 12 and an electroluminescent light-emitting layer (EL light-emitting layer) 13. The electroluminescent light-emitting layer 13 is formed by dispersing electroluminescent light-emitting particles which emit a predetermined color of light in a dielectric binder. The color display also includes a second insulating layer 14 and an optically transparent second electrode layer 15, which transmits light. The color display also includes a thin-film support member 16, a color conversion filter layer 17 and a protective layer 18. The color conversion filter layer 17 includes color conversion portions and transparent portions (filter portions). In the color display, the white support member 10, first electrode layer 11, first insulating layer 12, electroluminescent light-emitting layer 13, second insulating layer 14, second electrode layer 15, thin-film support member 16, color conversion filter layer 17 and protective layer 18 are superposed in this order.

The white support member 10 is a resin film, such as PET (polyethylene terephthalate) sheet, which contains a white pigment and/or void. The white support member 10 has a light scatter reflection function.

The thin-film support member 16 is a resin film such as transparent PET. The thickness of the thin-film support member 16 is approximately 3 μm through 20 μm.

The protective layer 18 is an optically transparent film or coating. Functions, such as contamination prevention, scratch protection, static prevention, reflection prevention or electromagnetic-wave shield, may be provided for the protective layer 18.

The first electrode layer 11 and the second electrode layer 15 are stripe electrode layers, in each of which a multiplicity of line-shaped electrodes is arranged in stripes. The first electrode layer 11 and the second electrode layer 15 are arranged so that the line-shaped electrodes of the first electrode layer 11 are orthogonal to the line-shaped electrodes of the second electrode layer 15 so as to form a simple matrix. Pixels are formed by the simple matrix. Each of the line-shaped electrodes may be formed by an optically transparent electrode, such as ITO (Indium-Tin Oxide) or ZnO:Al. Alternatively, each of the line-shaped electrodes maybe formed with a mesh metal or stripe-shaped metal. Alternatively, the mesh metal or the stripe-shaped metal may be used in combination with the transparent electrode mentioned above to form the stripe electrode layer.

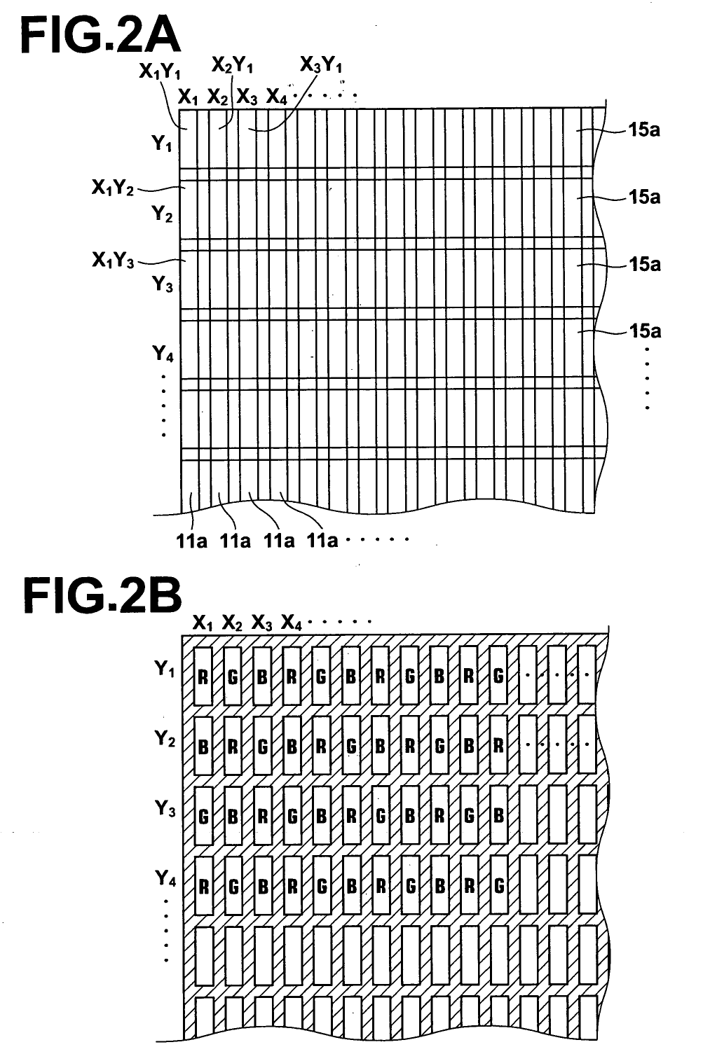

FIG. 2A is a diagram illustrating an X-Y matrix structure formed by stripe electrode layers. FIG. 2B is a plan view illustrating a part of the color conversion filter layer 17 which is arranged based on the X-Y matrix. In FIGS. 2A and 2B, the positions of pixels with respect to the X direction are represented using X₁, X₂, X₃, . . . and the positions of pixels with respect to the Y direction are represented using Y₁, Y₂, Y₃, . . . .

Line-shaped electrodes 11a of the first electrode layer 11 and line-shaped electrodes 15a of the second electrode layer 15 are arranged so that they are substantially orthogonal to each other. A pitch of arrangement of the line-shaped electrodes 11a regulates a pitch of pixels with respect to the arrangement direction of the line-shaped electrodes 11a. A pitch of arrangement of the line-shaped electrodes 15a regulates a pitch of pixels with respect to the arrangement direction of the line-shaped electrodes 15a. The line-shaped electrodes 11a or 15a are arranged so that the number of the line-shaped electrodes 11a or 15a is the same as the number of pixels desired with respect to the arrangement direction of the line-shaped electrodes 11a or 15a, respectively. Portions (intersections) of the line-shaped electrodes 11a of the electrode layer 11 and the line-shaped electrodes 15a of the electrode layer 15, at which the line-shaped electrodes 11a and 15a cross each other, form pixels X₁Y₁, X₂Y₁, X₃Y₁, . . . , X₁Y₂, X₂Y₂, . . . .

As illustrated in FIG. 2B, in the color conversion filter layer 17, a red conversion portion R, a green conversion portion G and a blue filter portion B are formed in turn. The red conversion portion R, the green conversion portion G and the blue filter portion B form an R pixel, G pixel and B pixel, respectively. The red conversion portion R converts blue light emitted from the light-emitting layer 13 to red light. The green conversion portion G converts blue light to green light. The blue filter portion B transmits blue light emitted from the light-emitting layer 13 to generate blue light, of which the purity is even higher. Further, a black matrix (shaded area in FIG. 2B) is formed. The black matrix is formed between adjacent color conversion portions, between adjacent transparent portions or between a color conversion portion and a transparent portion which are adjacent to each other. The black matrix forms an absorption portion which absorbs at least a part of light emitted from the light-emitting layer. Here, it is assumed that blue light is emitted from the light-emitting layer 13.

The color conversion filter layer 17 is superposed on the thin-film support member 16 so that each of the red conversion portions R, green conversion portions G and blue filter portions B of the color conversion filter layer 17 is matched with an intersection (each pixel) of the line-shaped electrodes. Specifically, a red conversion portion R is positioned at pixel X₁Y₁, and a green conversion portion G is positioned at pixel X₂Y₁. Further, a blue filter portion B is positioned at pixel X₃Y₁ and a red conversion portion R is positioned at pixel X₄Y₁, . . . . The color conversion filter layer 17 is arranged so that the pixels are in one-to-one correspondence with the color conversion portions or filter portions.

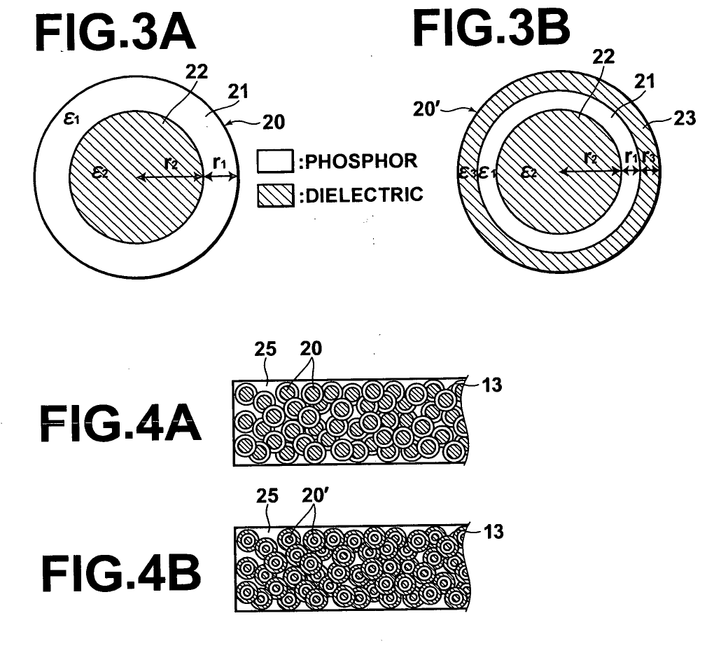

The EL light-emitting layer 13 is a plane-shaped light-emitting layer, in which a multiplicity of electroluminescent light-emitting particles is dispersed in a dielectric binder. As the electroluminescent light-emitting particles, the electroluminescent light-emitting particles disclosed in Japanese Unexamined Patent Publication No. 2005-203336 may be used. The electroluminescent light-emitting particles disclosed in Japanese Unexamined Patent Publication No. 2005-203336 are illustrated in FIG. 3A or 3B. In the electroluminescent light-emitting particle 20, illustrated in FIG. 3A, a phosphor coating layer 21 which has a layer thickness r₁ and a relative dielectric constant ε₁ is formed on a dielectric core 22 which has a core radius r₂ and a relative dielectric constant ε₂. Alternatively, in the electroluminescent light-emitting particle 20′, illustrated in FIG. 3B, a phosphor coating layer 21 which has a layer thickness r₁ and a relative dielectric constant ε₁ is formed on a dielectric core 22 which has a core radius r₂ and a relative dielectric constant ε₂. In the 10 electroluminescent light-emitting particle 20′, a dielectric coating layer 23 which has a layer thickness r₃ and a relative dielectric constant ε₃ is further provided on the phosphor coating layer 21.

In either case of using the electroluminescent light-emitting particles 20 or 20′, when a voltage is applied between the first electrode layer 11 and the second electrode layer 15, the strength of an average voltage applied to the phosphor coating layer 21 is greater than or equal to 1.5 times that of an average electric field applied to the entire light-emitting layer.

When the electroluminescent light-emitting particle 20 including the dielectric core 22 and the phosphor coating layer 21, as illustrated in FIG. 3A, is used, it is preferable that the layer thickness r₁ of the phosphor coating layer 21 and the radius r₂ of the dielectric core 22 satisfy the condition that the value of r₂/r₁ is greater than or equal to 1.0 approximately. Further, it is preferable that the relative dielectric constant ε₁ of the phosphor coating layer 21 and the relative dielectric constant ε₂ of the dielectric core 22 satisfy the condition that the value of ε₂/ε₁ is greater than 2.0 approximately. Further, in this case, it is preferable that the average core diameter of the dielectric core 22 of each of the multiplicity of electroluminescent light-emitting particles 20 is greater than or equal to 1.2 μm approximately.

Meanwhile, when the electroluminescent light-emitting particle 20′ including the dielectric core 22, the phosphor coating layer 21 and the dielectric coating layer 23, as illustrated in FIG. 3B, is used, it is preferable that the layer thickness r₁ of the phosphor coating layer 21, the radius r₂ of the dielectric core 22 and the layer thickness r₃ of the dielectric coating layer 23 satisfy the condition that the ratio of r₂/r₁ is greater than or equal to 1.0 approximately and the condition that the ratio of r₃/(r₁+r₂) is less than 0.50 approximately. Further, it is preferable that the relative dielectric constant ε₁ of the phosphor coating layer, the relative dielectric constant ε₂ of the dielectric core, and the relative dielectric constant ε₃ of the dielectric coating layer satisfy the condition that the ratio of ε₂/ε₁ is greater than or equal to 2.0 approximately and that the ratio of ε₃/ε₁ is less than 20 approximately.

FIGS. 4A and 4B illustrate examples of a light-emitting layer. FIGS. 4A and 4B are partial sectional views of the light-emitting layer. FIG. 4A is a diagram illustrating a part of a light-emitting layer, in which the electroluminescent light-emitting particles 20, illustrated in FIG. 3A, are dispersed in a dielectric binder 25. FIG. 4B is a diagram illustrating a part of a light-emitting layer, in which the electroluminescent light-emitting particles 20′, illustrated in FIG. 3B, are dispersed in a dielectric binder 25. In either case of using the electroluminescent light-emitting particles 20 or 20′, it is preferable that the volume filling ratio of the light-emitting particles in the light light-emitting layer 13 is sufficiently large, and that the volume filling ratio is greater than or equal to 40%. It is even preferable that the volume filling ratio is greater than or equal to 60%. Further, it is preferable that the layer thickness of the light-emitting layer is less than or equal to 100 μm. If the light-emitting layer 13, as described above, is provided, it is possible to emit extremely high-brightness light.

In the color display according to the present invention, each of the line-shaped electrodes 11a in the first electrode layer 11 and each of the line-shaped electrodes 15a in the second electrode layer 15 are connected to a voltage drive circuit, which is not illustrated. The voltage drive circuit controls application of a voltage to pixels at intersections between the line-shaped electrodes 11a and the line-shaped electrodes 15a, and light is generated at a pixel to which the voltage is applied. Then, the light is emitted from the light-emitting layer 13. The light emitted from the light-emitting layer 13 is transmitted through the color conversion portion or the filter portion, and emitted from the side of the protective layer 18.

A method for producing the color display will be described.

1) An optically transparent electrode layer 11 is formed on a white support member 10. The optically transparent electrode layer 11 is formed by sputtering, vapor-deposition (evaporation), application or the like.

2) An insulating layer 12 is formed (applied) on the optically transparent electrode layer 11.

3) An optically transparent electrode layer 15 is formed on a thin-film support member. The thin-film support member is a composite film, in which a thin-film support member 16 is attached to a thick temporary support member in a manner in which the thin-film support member 16 can be peeled therefrom. The optically transparent electrode layer 15 may be formed by sputtering, evaporation, application or the like. A PET film which has an adhesive layer on the side in contact with the thin-film support member is used as the temporary support member so that the temporary support member can be peeled from the thin-film support member.

4) An insulating layer 14 is formed on the optically transparent electrode layer 15. Then, a light-emitting layer 13 is further formed (applied) on the insulating layer 14. The light-emitting layer 13 is formed, for example, by dispersing electroluminescent light-emitting particles 20 (or 20′) in a cyanoethyl cellulose solution to obtain a dispersion. Further, the dispersion is applied on the insulating layer 12 and dried. The cyanoethyl cellulose solution is made by mixing cyanoethyl cellulose, which is a material for the dielectric binder 25, with N, N′-dimethylformamide, which is a solvent, in the volume ratio of cyanoethyl cellulose:N,N′-dimethylformamide=3:7. Here, the electroluminescent light-emitting particle 20 illustrated in FIG. 3A may be produced, for example, by forming a phosphor coating layer 21 made of BaAl₂S₄:Eu on a dielectric core 22 which has a desired size by using a sputtering method. Further, the electroluminescent light-emitting particle 20′ illustrated in FIG. 3B may be produced, for example, by forming a phosphor coating layer 21 made of BaAl₂S₄:Eu on a dielectric core 22 which has a desired size by using a sputtering method and by further forming a dielectric coating layer 23 on the phosphor coating layer 21 by using a sol-gel method.

5) The portion, in which the optically transparent electrode layer 11 and the insulating layer 12 are superposed on the support member 10 in this order, and the portion, in which the optically transparent electrode layer 15, the insulating layer 14 and the light-emitting layer 13 are superposed on the thin-film support member 16 in this order, are attached to each other so that the insulating layer 12 and the light-emitting layer 13 face each other. Then, the temporary support member is peeled from the thin-film support member 16.

6) A lead wire is connected to each of the line-shaped electrodes of the optically transparent electrode layer 11 and each of the line-shaped electrodes of the optically transparent electrode layer 15.

7) A color conversion filter layer 17 including color conversion portions and filter portions is produced. The color conversion filter layer 17 is produced so that the color conversion portions and filter portions correspond to pixels regulated by the electrode layers which form an X-Y matrix. The color conversion filter layer 17 may be formed by performing steps similar to those of production of a color filter, for example, by using a transer system. In the transer system, a photosensitive resin layer is transferred onto a glass substrate (glass plate) by using a laminator, and a color filter is produced through an exposure process and a development process. In this example, the light-emitting layer emits blue light. Therefore, a color conversion filter layer 17 including red conversion portions, green conversion portions and blue filter portions is produced. Each of the red conversion portions includes a phosphor which emits red light by being excited by blue light. Each of the green conversion portions includes a phosphor which emits green light by being excited by blue light. Each of the blue filter portions improves the purity of the blue, if necessary.

8) The color conversion filter layer 17 is attached so that the color conversion filter layer 17 is appropriately positioned with respect to the electrodes.

9) A protective layer 18 is formed on the color conversion filter layer 17. Further, the whole element (device) may be sealed with a seal film to improve moisture resistance.

The color display, as described above, includes a light-emitting layer which emits extremely high brightness light. Further, since the drive method of the color display is a method using a very simple matrix electrode, the structure of the color display is simple. Therefore, a method for producing the color display is also simple, and the color display can be provided at low cost.

Please note that the material for forming each layer of the electroluminescent display device or the electroluminescent light-emitting particles and the layer structure of the electroluminescent display device are not limited to those described in the above embodiment.

As the material for the phosphor coating layer 21 of each of the electroluminescent light-emitting particles 20 or 20′, a material which emits ultra-violet light or blue light is preferable. A phosphor which emits ultra-violet light is ZnF₂:Gd or the like. A phosphor which emits blue light is BaAl₂S₄:Eu, CaS:Pb, SrS:Ce, SrS:Cu, CaGa₂S₄:Ce, or the like.

Needless to say, the formation of the color conversion portions and the filter portions of the color conversion filter layer 17 is required to be changed based the wavelength of light emitted from the electroluminescent light-emitting particles. As the phosphor provided in the color conversion portions, a phosphor, such as a blue-light-emitting phosphor, green-light-emitting phosphor or red-light-emitting phosphor, which is excited by the light emitted from the electroluminescent light-emitting particles is appropriately adopted based on the color of light emitted from the electroluminescent light-emitting particles. Table 1 shows examples of a phosphor provided in the color conversion portion. Table 1 shows examples of a phosphor which emits blue light, green light and red light by UV (ultra-violet) excitation or blue excitation.

TABLE 1

| | | Blue |
|---|---|---|
| | UV Excitation | Excitation |
| Blue-Light- | (Sr, Ba, Ca)₅(PO₄)₃Cl:Eu | |
| Emitting | | |
| Phosphor | | |
| Green-Light- | BaMg₂Al₁₆O₂₇:Eu, Mn, | Y₃Al₅O₁₂:Ce |
| Emitting | ZnS:Cu, Al | (yellow), |
| Phosphor | | Ca₃Se₂Si₃O₁₂:Ce |
| Red-Light- | (Ca, Sr)S:Eu, Y₂O₂S:Eu, | (Ca, Sr)S:Eu, |
| Emitting | 3.5 MgO.0.5 MgF₂.GeO₂:Mn, | CaAlSiN₃:Eu |
| Phosphor | Ba₃MgSi₂O₈:Eu, Mn, CaAlSiN₃:EU | |

In the above embodiment, a full-color display is used as an example. However, if a full-color display is not required, it is not always necessary to provide two kinds of color conversion portions in the color conversion filter layer 17. Only one kind of color conversion portions may be provided in the color conversion filter layer 17. Further, since the filter portions are provided to improve the purity of the emitted light, if light which has high purity is not required, it is not necessary to provide the filter portions. In that case, optically transparent portions which transmit the emitted light without changing the quality of light may be provided instead of the filter portions.

The dielectric core 22 and the dielectric coating layer 23 of each of the electroluminescent light-emitting particles 20 or 20′ may be made of BaTiO₃, SrTiO₃, HfO₂, SiO₂, TiO₂, A₂O₃, Y₂O₃, Ta₂O₅, BaTa₂O₆, Sr(Zr,Ti)O₃, PbTiO₃, Si₃N₄, ZnS, ZrO₂, PbNbO₃, Pb(Zr,Ti)O₃ or the like. The same material may be used to form the dielectric coating layer 23 and the dielectric core 22. However, it is preferable to use a material which has higher relative dielectric constant as the material for the dielectric core 22 to suppress the shield effect of the dielectric coating layer 23 and to efficiently apply an electric field to the phosphor coating layer 21.

As the material for the dielectric binder 25 of the light-emitting layer 13, cyanoethyl cellulose, epoxy resin, polyethylene, polypropylen, polystyrene-based resin, silicon resin, vinylidene fluoride resin or the like may be used. Further, ultra-fine particles made of a dielectric, such as BaTiO₃ or SrTiO₃, which has a high dielectric constant may be mixed with the above materials to adjust the dielectric constant, and the material, of which the dielectric constant has been adjusted, may be used.

It is not always necessary to provide the first insulating layer 12 or the second insulating layer 14. As the material for the insulating layers 12 and 14, a material similar to the material for the dielectric binder 25 of the light-emitting layer 13 may be used. Alternatively, a thin film made of the material for the dielectric core 22 or the dielectric coating layer 23 of each of the electroluminescent light-emitting particles 20 or 20′ may be used as the insulating layer 12 or 14. It is preferable to use a material which has a high dielectric constant, and of which the insulation breakdown does not easily occur, so that a high voltage is stably applied to the light-emitting layer.

As a material for the optically transparent first electrode layer or the optically transparent second electrode layer, ITO, ZnO:Al, as described above, may be used. Further, a material containing Zn₂In₂O₅, (Zn,Cd,Mg)O—(B,Al,Ga,In,Y)₂O₃—(Si,Ge,Sn,Pb,Ti,Zr)O₂, (Zn,Cd,Mg)O—(B,Al,Ga,In,Y)₂O₃—(Si,Sn,Pb)O, MgO—In₂O₃ or the like as a main component may be also used as the material for the first or second electrode layer. Further, a GaN-based material, SnO₂-based material or the like may also be used as the material for the first or second electrode layer. Alternatively, a thin film made of Au or metal mesh may be used as the material for the first or second electrode layer. Further, these materials may be used in combination.

What is claimed is:

1. An electroluminescent display device comprising:
a support member;
a first electrode layer;
a plane-shaped light-emitting layer;
a second electrode layer which transmits light; and
a color conversion filter layer, wherein the plane-shaped light-emitting layer is formed by dispersing electroluminescent light-emitting particles which emit a predetermined color of light in a dielectric binder, and wherein the color conversion filter layer includes a multiplicity of color conversion portions which convert the color of the light and/or a multiplicity of transparent portions which transmit the light, and wherein the support member, first electrode layer, plane-shaped light-emitting layer, second electrode layer and color conversion filter layer are superposed in this order, and wherein each of the first electrode layer and the second electrode layer includes a plurality of line-shaped electrodes, and wherein the plurality of line-shaped electrodes of the first electrode layer and that of the second electrode layer cross each other, and wherein the plane-shaped light emission layer is uniformly formed over the entire area of the electroluminescent display device.

2. An electroluminescent display device as defined in claim 1, wherein the plurality of line-shaped electrodes of the first electrode layer and that of the second electrode layer are orthogonal to each other.

3. An electroluminescent display device as defined in claim 1, wherein at least one insulating layer is provided between the first electrode layer and the second electrode layer.

4. An electroluminescent display device as defined in claim 1, wherein the color conversion filter layer is arranged so that each of display pixels formed by intersections of the plurality of line-shaped electrodes of the first electrode layer and that of the second electrode layer, which cross each other, corresponds to one of the color conversion portions or one of the transparent portions.

5. An electroluminescent display device as defined in claim 4, wherein the color conversion filter layer includes an absorption portion which is formed between adjacent color conversion portions, between adjacent transparent portions or between a color conversion portion and a transparent portion which are adjacent to each other, wherein the absorption portion absorbs at least a part of light emitted from the light-emitting layer.

6. An electroluminescent display device as defined in claim 5, wherein the color of the absorption portion is black

7. An electroluminescent display device as defined in claim 1, wherein each of the electroluminescent light-emitting particles includes a dielectric core and a phosphor coating layer which is formed on the outside of the dielectric core, wherein when a voltage is applied between the first electrode layer and the second electrode layer, the strength of an average voltage applied to the phosphor coating layer is more than or equal to 1.5 times that of an average electric field applied to the entire light-emitting layer.

8. An electroluminescent display device as defined in claim 1, wherein each of the electroluminescent light-emitting particles includes a dielectric core, a phosphor coating layer which is formed on the outside of the dielectric core and a dielectric coating layer which is formed on the outside of the phosphor coating layer, wherein when a voltage is applied between the first electrode layer and the second electrode layer, the strength of an average voltage applied to the phosphor coating layer is more than or equal to 1.5 times that of an average electric field applied to the entire light-emitting layer.
